(19) United States
(12) Patent Application Publication
(10) Pub. No.: US 2008/0036647 A1
(43) Pub. Date: Feb. 14, 2008

(54) METHOD AND APPARATUS FOR MEASURING DISTANCE BETWEEN BLUETOOTH TERMINALS

(75) Inventor: Jin-He Jung, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/835,889

(22) Filed: Aug. 8, 2007

(30) Foreign Application Priority Data
Aug. 8, 2006 (KR) 2006-74936

(51) Int. Cl. G01S 11/06

(52) U.S. Cl. 342/118

(57) ABSTRACT

Disclosed is a method for measuring a distance between portable Bluetooth terminals. The method includes transmitting first distance measurement radio waves to a specific portable Bluetooth terminal corresponding to user selection from among one or more portable Bluetooth terminals which can be connected through Bluetooth; and if second distance measurement radio waves are received from the specific portable Bluetooth terminal, detecting a distance corresponding to an intensity of the received second distance measurement radio waves, and notifying a user of the detected distance.

### PRIORITY

This application claims priority to an application entitled “Method And Apparatus For Measuring Distance Between Bluetooth® Terminals” filed in the Korean Intellectual Property Office on Aug. 8, 2006 and assigned Serial No. 2006-74936, the contents of which are hereby incorporated by reference.

### BACKGROUND OF THE INVENTION

1. Field of the Invention

The present invention relates to a portable Bluetooth® (hereinafter “Bluetooth”) terminal having a Bluetooth module therein, and more particularly to a method and an apparatus for measuring a distance between portable Bluetooth terminals.

2. Description of the Related Art

With the development of Bluetooth technology, various portable terminals having a Bluetooth module therein have been commercialized. A Bluetooth module is provided to a portable terminal, so that a user can use a wireless handsfree device, or various convenient functions including data transmission/reception between two terminals, etc. As a result of functions having a direct relation to a Bluetooth function, there has been an increase in convenience for a user. For example, if a portable terminal communicating with a certain Bluetooth terminal by using a Bluetooth communication scheme moves beyond a Bluetooth communication range, a function for generating a warning sound reporting this may be included in the afore-described functions. However, while such a function may inform the user of the portable terminal that the portable terminal has moved beyond the Bluetooth communication range, it cannot report a distance between the two Bluetooth terminals. If it is possible to become aware of the distance, it may be helpful for finding a communication partner.

The position estimation of a portable terminal may be performed through a GPS or sensors including a gyro sensor, but manufacturing cost may increase when the GPS or gyro sensor is installed in the portable terminal. Further, the consumption of power for operating portable terminal may increase due to the GPS or gyro sensor.

### SUMMARY OF THE INVENTION

Accordingly, the present invention has been made to solve the above-mentioned problems occurring in the prior art, and an aspect of the present invention is to provide a method and an apparatus capable of becoming aware of a distance between terminals respectively equipped with Bluetooth modules by using Bluetooth technology, without using other devices.

In accordance with one aspect of the present invention, there is provided a method for measuring a distance between portable Bluetooth terminals, the method including transmitting first distance measurement radio waves to a specific portable Bluetooth terminal corresponding to a user selection from among one or more portable Bluetooth terminals which can be connected through Bluetooth; and if second distance measurement radio waves are received from the specific portable Bluetooth terminal, detecting a distance corresponding to an intensity of the received second distance measurement radio waves, and notifying a user of the detected distance.

In accordance with another aspect of the present invention, there is provided a method for measuring a distance between portable Bluetooth terminals, the method including transmitting a transmission request message of first distance measurement radio waves to a specific portable Bluetooth terminal corresponding to a user selection from among one or more portable Bluetooth terminals which can be connected through Bluetooth; and if transmission request radio waves of second distance measurement radio waves are received from the specific portable Bluetooth terminal, detecting a distance corresponding to an intensity of the received second distance measurement radio waves, and notifying a user of the detected distance.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating the construction of a portable Bluetooth terminal according to one embodiment of the present invention; and

FIG. 2 is a diagram illustrating a distance change between portable Bluetooth terminals according to one embodiment of the present invention; and

FIG. 3 is a flow diagram illustrating the operation process of a portable Bluetooth terminal according to one embodiment of the present invention.

### DETAILED DESCRIPTION OF THE PREFERRED EMBODIMENT

A preferred embodiment of the present invention will be described in detail herein below with reference to the accompanying drawings. It should be noted that similar components are designated by similar reference numerals although they are illustrated in different drawings. Also, in the following description, a detailed description of known functions and configurations incorporated herein will be omitted when it may obscure the subject matter of the present invention.

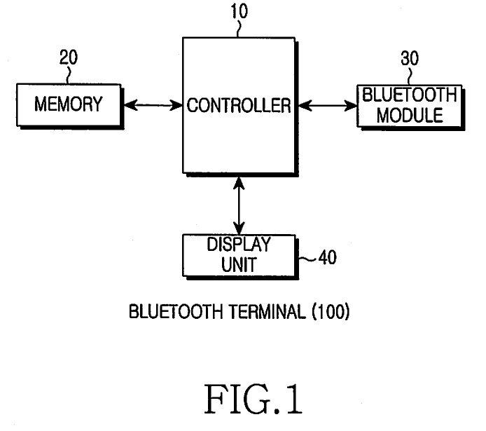

FIG. 1 is a block diagram illustrating the construction of the portable Bluetooth terminal according to one embodiment of the present invention. In the present invention, the term “portable Bluetooth terminal” denotes a user terminal equipped with a Bluetooth module, and may include a mobile communication terminal, an MP3, a Portable Multimedia Player (PMP), a Personal Digital Assistant (PDA), a Bluetooth wireless headset, etc.

As illustrated in FIG. 1, the portable Bluetooth terminal 100 includes a controller 10, a memory 20, a Bluetooth module 30, and a display unit 40. The controller 10 controls the general operation of the portable Bluetooth terminal 100. The display unit 40 displays data stored in the memory 20 under the control of the controller 10, or displays data received through the Bluetooth module 30.

The memory 20 stores programs for processing and control operations of the controller 10, reference data, various updatable storage data, etc., and functions as a working memory of the controller 10. The memory 20 stores program data related to a distance measurement mode, and a distance measurement database according to one embodiment of the present invention. In the distance measurement mode, distance measurement radio waves with a predetermined intensity are transmitted/received through a specific portable Bluetooth terminal selected by a user and the Bluetooth module 30, and a distance of a portable Bluetooth terminal of a communication partner is measured based on the intensity of the distance measurement radio waves. The distance measurement radio waves have a predetermined intensity, and may include an identifier indicating the distance measurement radio waves, and a transmission-side ID. The distance measurement database is a database in which distances corresponding to the intensity of the distance measurement radio waves are mapped. The distance measurement database can be formed by repeating a test which transmits/receives the distance measurement radio waves while changing a distance between two Bluetooth modules, and measures the intensity of the transmitted/received distance measurement radio waves.

If the distance measurement mode is set according to one embodiment of the present invention, the controller 10 having the construction as described above provides a user with a list of Bluetooth terminals located within a measurable distance. These Bluetooth terminals denote Bluetooth terminals existing within a distance in which Bluetooth communication is possible, and may also include Bluetooth terminals scanned in an inquiry process as well as currently Bluetooth-connected terminals. A user selects a terminal to be subjected to distance measurement from provided terminals, and the controller 10 periodically transmits first distance measurement radio waves to a specific Bluetooth terminal corresponding to the selection through the Bluetooth module 30. Herein, if the specific Bluetooth terminal is not a Bluetooth-connected terminal, the controller 10 transmits distance measurement radio waves after performing Bluetooth connection. Then, if second distance measurement radio waves are received from the specific Bluetooth terminal through the Bluetooth module 30, the controller 10 measures the intensity of the received second distance measurement radio waves, detects a distance corresponding to the measured intensity from a pre-stored distance measurement database, according to intensities of distance movement radio waves, and provides the detected distance to the user. Further, if the controller 10 receives distance measurement radio waves from a certain Bluetooth terminal in a state where the distance measurement has not been set as well as in a state where the distance measurement has been set, the controller 10 transmits distance measurement signals to the certain Bluetooth terminal. In this way, the certain Bluetooth terminal can become aware of a distance with the portable Bluetooth terminal 100.

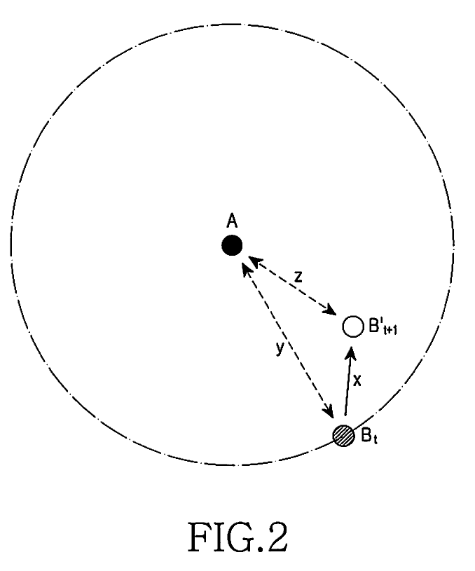

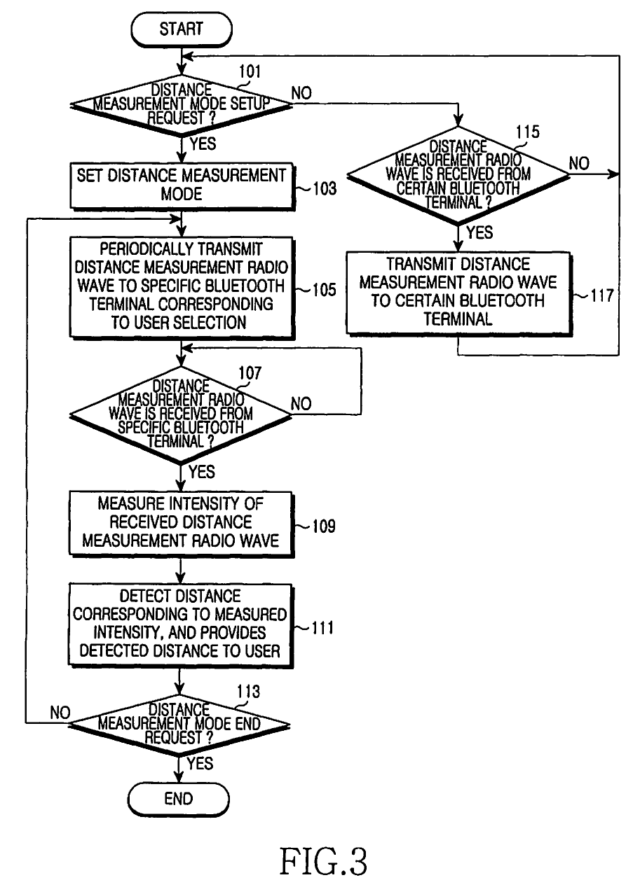

Hereinafter, a process for measuring a distance between two portable Bluetooth terminals having the same construction as that of the portable Bluetooth terminal 100, and providing the measured distance to a user according to one embodiment of the present invention will be described with reference to FIGS. 2 and 3. FIG. 2 is a diagram illustrating a distance change between the portable Bluetooth terminals and FIG. 3 is a flow diagram illustrating the operation process of the portable Bluetooth terminal.

Referring to FIG. 2, it is assumed that a first portable Bluetooth terminal and a second portable Bluetooth terminal have a construction similar to that of portable Bluetooth terminal 100, the first portable Bluetooth terminal is located at point A, the second portable Bluetooth terminal is located at point Bₜ, the first portable Bluetooth terminal does not move, but the second portable Bluetooth terminal moves. Herein, the second portable Bluetooth terminal moves from point Bₜ to point B′₍ₜ₊₁₎ by a distance x. Accordingly, the initial distance between the first portable Bluetooth terminal and the second portable Bluetooth terminal is y from point A to point Bₜ. After the second portable Bluetooth terminal moves by distance x, a distance between the first portable Bluetooth terminal and the second portable Bluetooth terminal is z from point A to point B′₍ₜ₊₁₎.

When the second portable Bluetooth terminal is located at point Bₜ, if a distance measurement mode setup request is input from a user in step 101 of FIG. 3, the second portable Bluetooth terminal sets a distance measurement mode in step 103. In step 105, the second portable Bluetooth terminal provides the user with a list of Bluetooth-connected Bluetooth terminals or a list of Bluetooth terminals capable of performing Bluetooth connection. The user selects a Bluetooth terminal (e.g. the first portable Bluetooth terminal) to be subjected to distance measurement from the Bluetooth terminals included in the provided list. In step 105, the second portable Bluetooth terminal periodically transmits first distance measurement radio waves to the specific Bluetooth terminal corresponding to the selection of the user, i.e. the first portable Bluetooth terminal.

If the first distance measurement radio waves are received from the second portable Bluetooth terminal, the first portable Bluetooth terminal transmits second distance measurement radio waves to the second portable Bluetooth terminal. Herein, if the first distance measurement radio waves are received regardless of whether a distance measurement mode has been set, the first portable Bluetooth terminal transmits the second distance measurement radio waves to the portable Bluetooth terminal having transmitted the first distance measurement radio waves.

If the second portable Bluetooth terminal confirms that the second distance measurement radio waves are received from the first portable Bluetooth terminal in step 107, the second portable Bluetooth terminal measures the intensity of the received second distance measurement radio waves in step 109. In step 111, the second portable Bluetooth terminal detects a distance (i.e., y) corresponding to the measured intensity, and provides the detected distance to the user. Accordingly, the user can become aware that the first portable Bluetooth terminal is located within the distance y.

As long as the distance measurement mode is set, i.e. as long as a distance measurement mode end request is not input in step 113, the second portable Bluetooth terminal repeats steps 105, 107, 109 and 111. In other words, the second portable Bluetooth terminal periodically transmits first distance measurement radio waves to the first portable Bluetooth terminal, detects a distance corresponding to the intensity of second distance measurement radio waves received from the first portable Bluetooth terminal, and provides the detected distance to the user. If the second portable Bluetooth terminal moves from point Bₜ to point B′₍ₜ₊₁₎, it is possible to detect a distance corresponding to the distance z at point B′₍ₜ₊₁₎.

If the second portable Bluetooth terminal receives distance measurement radio waves from a certain Bluetooth terminal in a state where the distance measurement mode has not been set, in step 115, the second portable Bluetooth terminal transmits third distance measurement signals to the certain Bluetooth terminal, so that the certain Bluetooth terminal can become aware of a distance with the second portable Bluetooth terminal, in step 117. Although not shown in FIG. 3, if distance measurement radio waves are received from another certain terminal (i.e. terminal not designated by a user) in a state where the distance measurement mode has been set, the second portable Bluetooth terminal transmits fourth distance measurement signals to said certain terminal. Herein, whether a distance with the certain terminal is detected using distance measurement radio waves received from the certain terminal can be set according to user selection.

According to the present invention as described above, distance measurement radio waves with a predetermined intensity are transmitted/received between portable Bluetooth terminals, a distance proportional to the intensity of received distance measurement radio waves is detected, and the detected distance is provided to a user, so that the user can become aware of a distance from a portable Bluetooth terminal of a communication partner even without adding a separate device, and can use the distance when determining a movement range in the future.

Although a preferred embodiment of the present invention has been described for illustrative purposes, those skilled in the art will appreciate that various modifications, additions and substitutions are possible, without departing from the scope and spirit of the present invention as disclosed in the accompanying claims, including the full scope of equivalents thereof. For example, in the afore-described embodiment, a portable Bluetooth terminal to be subjected to distance measurement transmits distance measurement radio waves to a Bluetooth terminal of a communication partner, and requests that the Bluetooth terminal of a communication partner transmit distance measurement radio waves. However, it may be possible to transmit a message requesting transmission of distance measurement radio waves to the Bluetooth terminal of a communication partner.

What is claimed is:

1. A method for measuring a distance between portable Bluetooth terminals, the method comprising the steps of:
transmitting first distance measurement radio waves of a predetermined intensity to a specific portable Bluetooth terminal corresponding to a user selection from among one or more portable Bluetooth terminals which can be connected through a Bluetooth communication scheme through a Bluetooth module;
if second distance measurement radio waves corresponding to the first distance measurement radio waves are received from the specific portable Bluetooth terminal through the Bluetooth module, detecting a distance corresponding to an intensity of the second distance measurement radio waves from a pre-stored distance measurement database according to intensities of distance measurement radio waves, and notifying the user of the detected distance; and
if certain radio waves except for the second distance measurement radio waves are received from a certain portable Bluetooth terminal, transmitting third distance measurement radio waves of a predetermined intensity corresponding to the certain distance measurement radio waves except for the second distance measurement radio waves to the certain portable Bluetooth terminal.

2. The method as claimed in claim 1, further comprising detecting a distance corresponding to an intensity of a certain distance measurement radio waves except for the second distance radio waves, and notifying a user of the detected distance.

3. The method as claimed in claim 2, wherein the distance measurement radio waves have a predetermined intensity, and include a distance measurement radio waves identifier, and an identifier of a portable Bluetooth terminal of a transmission-side.

4. The method as claimed in claim 3, wherein, in transmitting the first distance measurement radio waves, the first distance measurement radio waves are periodically transmitted to the specific portable Bluetooth terminal.

5. A method for measuring a distance between portable Bluetooth terminals, the method comprising the steps of:
transmitting a transmission request message of distance measurement radio waves to a specific portable Bluetooth terminal corresponding to a user selection from among one or more portable Bluetooth terminals which can be connected through Bluetooth;
if transmission request radio waves of distance measurement radio waves are received from the specific portable Bluetooth terminal through the Bluetooth module, detecting a distance corresponding to an intensity of the received distance measurement radio waves from a pre-stored distance measurement database according to intensity of the distance measurement radio waves, and notifying the user of the detected distance; and
if the transmission request message is received from a certain portable Bluetooth terminal, transmitting the distance measurement radio waves as an intensity of the predetermined distance measurement radio waves to the certain portable Bluetooth terminal.

6. The method as claimed in claim 5, wherein the distance measurement radio waves have a predetermined intensity, and include a distance measurement radio waves identifier, and an identifier of a portable Bluetooth terminal of a transmission-side.

7. The method as claimed in claim 5, wherein, in transmitting the transmission request message, the transmission request message is periodically transmitted to the specific portable Bluetooth terminal.

8. An apparatus for measuring a distance between portable Bluetooth terminals, the apparatus comprising:
a Bluetooth module; and
a controller for controlling the Bluetooth module, transmitting first distance measurement radio waves as an intensity of the predetermined distance measurement radio waves to a specific portable Bluetooth terminal corresponding to a user selection from among one or more portable Bluetooth terminals which can be connected through Bluetooth through the Bluetooth module, receiving second distance measurement radio waves corresponding to the first distance measurement radio waves from the specific portable Bluetooth terminal through the Bluetooth module, detecting a distance corresponding to an intensity of the second distance measurement radio waves from pre-stored distance measurement database according to intensity of the distance measurement radio waves, notifying the user of the detected distance, and if third distance measurement radio waves are received from a certain portable Bluetooth terminal, transmitting a fourth distance measurement radio waves as an intensity of the predetermined distance measurement radio waves to the certain portable Bluetooth terminal.

9. The apparatus as claimed in claim 8, wherein the control detects a distance corresponding to an intensity of the third distance measurement radio waves, and notify a user of the detected distance.

10. An apparatus for measuring a distance between portable Bluetooth terminals, the apparatus comprising:
a Bluetooth module; and
a controller for controlling the Bluetooth module, transmitting first distance measurement radio waves as an intensity of the predetermined distance measurement radio waves to a plurality of specific portable Bluetooth terminals corresponding to a user selection from among one or more portable Bluetooth terminals which can be connected through Bluetooth through the Bluetooth module, receiving second distance measurement radio waves corresponding to the first distance measurement radio waves from a plurality of specific portable Bluetooth terminal through the Bluetooth module, detecting a distance corresponding to an intensity of the second distance measurement radio waves from pre-stored distance measurement database according to intensity of the distance measurement radio waves, notifying the user of the detected distance, and if a certain distance measurement radio waves except for the second distance measurement radio waves are received from a certain portable Bluetooth terminal, transmitting third distance measurement radio waves as an intensity of the predetermined distance measurement radio waves to the certain portable Bluetooth terminal.
